(19) United States
(12) Patent Application Publication
(10) Pub. No.: US 2017/0206209 A1
(43) Pub. Date: Jul. 20, 2017

(54) JUNK DIRECTORY IDENTIFICATION METHOD AND APPARATUS

(71) Applicant: BEIJING KINGSOFT INTERNET SECURITY SOFTWARE CO., LTD., Beijing (CN)

(72) Inventors: Guoqiang JIAO, Beijing (CN); Qidong YANG, Beijing (CN); Xiliang BAI, Beijing (CN); Xueshi DU, Beijing (CN); Nan ZHANG, Beijing (CN); Yong CHEN, Beijing (CN)

(73) Assignee: Beijing Kingsoft Internet Security Software Co., Ltd., Beijing (CN)

(21) Appl. No.: 15/321,694

(22) PCT Filed: Jun. 24, 2015
(86) PCT No.: PCT/CN2015/082211

§ 371 Date: Dec. 22, 2016

(30) Foreign Application Priority Data
Jun. 30, 2014 (CN) 201410307300.4

(51) Int. Cl. G06F 17/30

(52) U.S. Cl. CPC G06F 17/30082; G06F 17/3012

(57) ABSTRACT

A junk directory identification method and apparatus. The junk directory identification method comprises: obtaining a directory to be identified; wherein, the directory to be identified is a directory generated after running of an application software; obtaining the file names of the files in the directory to be identified; determining whether the file names of the files in the directory to be identified all conform to temporary file naming rule; if so, determining the directory to be identified as a junk directory. Hence, the present solution uses a method of determining whether the file names of the files in the directory to be identified all conform to the temporary file naming rule to identify whether a directory to be identified is junk file, making full use of the unique naming method when a directory automatically created by a software application caches files, and can therefore effectively identify whether a directory in an application software is a junk directory.

The present application claims the priority of the Chinese patent application No. 201410307300.4, filed to the PRC Patent Office on Jun. 30, 2014 and entitled “JUNK DIRECTORY IDENTIFICATION METHOD AND APPARATUS”, the entire contents thereof are incorporated by reference in the present application.

### TECHNICAL FIELD

The present application relates to the field of file processing, and particularly to a method and apparatus for identifying a junk directory.

### BACKGROUND ART

With the rapid development of science and technology, various electronic devices are enriched constantly and facilitate people's lives. Electronic devices become an indispensable part of people's lives or work, since processing information with electronic apparatuses has an advantage of being convenient, quick, resource-saving and the like.

In the prior art, in electronic devices, various application software can be usually installed so as to satisfy various needs of users. However, due to improper development specifications of the application software, the application software will usually create some directories automatically during the operation of the application software by users, and each directory can direct to one folder, in which (i.e. under the directory) some files will be cached, wherein the cached picture files can usually account for more than 80% of the total number of files; and these cached files are usually useless for the user, which makes a large amount of storage space to be occupied by useless files, thereby affecting the overall performance of the electronic apparatuses.

Based on the above mentioned improper operation mechanism of application software, it is an urgent problem to identify whether a directory in an application software is a junk directory (i.e., a directory cached with files that are useless for a user).

### SUMMARY OF THE INVENTION

In view of the above mentioned problems, the embodiments of the present application disclose a method and apparatus for identifying a junk directory, so as to identify whether a directory in application software is a junk directory. The technical solutions are as follows.

In a first aspect, embodiments of the present application provide a method for identifying a junk directory, which comprises:

obtaining a directory to be identified, wherein, the directory to be identified is a directory generated after running of application software;

obtaining file names of files in the directory to be identified;

determining whether the file names of the files in the directory to be identified all conform to a temporary file naming rule; and

if so, determining the directory to be identified as a junk directory.

Optionally, before obtaining file names of files in the directory to be identified, the method further comprises:

obtaining the number of the files in the directory to be identified; and

determining whether the number of the files reaches a predetermined number, and if so, executing the step of obtaining file names of files in the directory to be identified again.

Optionally, the step of determining whether the file names of the files in the directory to be identified all conform to a temporary file naming rule comprises:

determining whether the file names of the files in the directory to be identified are all named with a numeric string having a predetermined number of digits, and if so, it is indicated that the file names of the files in the directory to be identified all conform to the temporary file naming rule.

Optionally, the step of determining whether the file names of the files in the directory to be identified all conform to a temporary file naming rule comprises:

determining whether the file names of the files in the directory to be identified are all named with a md5 character string, and if so, it is indicated that the file names of the files in the directory to be identified all conform to the temporary file naming rule.

Optionally, the step of determining whether the file names of the files in the directory to be identified all conform to a temporary file naming rule comprises:

determining whether the file names of the files in the directory to be identified are all named with a numeric string having a predetermined number of digits, and if so, it is indicated that the file names of the files in the directory to be identified all conform to the temporary file naming rule; and

if not, continuing to determine whether the file names of the files in the directory to be identified are all named with a md5 character string, and if so, it is indicated that the file names of the files in the directory to be identified all conform to the temporary file naming rule.

Optionally, the step of obtaining file names of files in the directory to be identified comprises:

obtaining file names of all files in the directory to be identified.

Optionally, the step of obtaining a directory to be identified comprises:

running the application software simulatively; and

optionally selecting, from directories generated after the simulative running of the application software, one directory as the directory to be identified.

Optionally, after determining the directory to be identified as a junk directory, the method further comprises:

reporting the directory to be identified to a server, so as to make the server to add the directory to be identified into a pre-established junk directory library;

or,

deleting a folder, to which the directory to be identified directs, automatically;

or,

outputting the directory to be identified, prompting a user whether to delete, and deleting a folder, to which the directory to be identified directs, after the user confirms to delete.

Optionally, after determining the directory to be identified as a junk directory, the method further comprises:

adding the directory to be identified into a pre-established junk directory library.

Optionally, the files are picture files.

In a second aspect, embodiments of the present application provide an apparatus for identifying a junk directory, which comprises:

a directory obtaining module for obtaining a directory to be identified, wherein, the directory to be identified is a directory generated after running of an application software;

a file name obtaining module for obtaining file names of files in the directory to be identified;

a file name determination module for determining whether the file names of the files in the directory to be identified all conform to a temporary file naming rule, and if so, triggering a junk directory determination module; and

the junk directory determination module for determining the directory to be identified as a junk directory.

Optionally, the embodiments of the present application provide an apparatus for identifying a junk directory, which further comprises:

a file number obtaining module for obtaining the number of files in the directory to be identified before obtaining the file names of the files in the directory to be identified; and

a file number determination module for determining whether the number of the files reaches a predetermined number, and if so, triggering the file name obtaining module.

Optionally, the file name determination module comprises:

a first file name determination unit for determining whether the file names of the files in the directory to be identified are all named with a numeric string having a predetermined number of digits, and if so, it is indicated that the file names of the files in the directory to be identified all conform to a temporary file naming rule, then triggering the junk directory determination module.

Optionally, the file name determination module comprises:

a second file name determination unit for determining whether the file names of the files in the directory to be identified are all named with a md5 character string, and if so, it is indicated that the file names of the files in the directory to be identified all conform to the temporary file naming rule, then triggering the junk directory determination module.

Optionally, the file name determination module comprises:

a second file name determination unit for determining whether the file names of the files in the directory to be identified are all named with a numeric string having a predetermined number of digits, and if so, it is indicated that the file names of the files in the directory to be identified all conform to the temporary file naming rule, then triggering the junk directory determination module; and

if not, continuing to determine whether the file names of the files in the directory to be identified are all named with a md5 character string, and if so, it is indicated that the file names of the files in the directory to be identified all conform to the temporary file naming rule, then triggering the junk directory determination module.

Optionally, the file names obtaining module is specifically used for:

obtaining file names of all files in the directory to be identified.

Optionally, the directory obtaining module comprises:

a simulation-running unit for running the application software simulatively; and

a directory determination unit for optionally selecting, from directories generated after the simulative running of the application software, one directory as the directory to be identified.

Optionally, the apparatus for identifying a junk directory provided by the embodiments of the present application further comprises:

a first processing module for reporting the directory to be identified to a server after the directory to be identified is determined as a junk directory, so as to make the server to add the directory to be identified into a pre-established junk directory library;

or,

a second processing module for automatically deleting a folder, to which the directory to be identified directs, after the directory to be identified is determined as a junk directory;

or,

a third processing module for outputting, after the directory to be identified is determined as a junk directory, the directory to be identified, prompting a user whether to delete, and deleting a folder, to which the directory to be identified directs, after the user confirms to delete.

Optionally, the apparatus for identifying a junk directory provided by the embodiments of the present application further comprises:

a fourth processing module for adding the directory to be identified into a pre-established junk directory library after the directory to be identified is determined as a junk directory.

Optionally, the files are picture files.

In a third aspect, embodiments of the present application further provide an electronic apparatus, which comprises a processor, a memory, communication interfaces and a bus;

the processor, the memory and the communication interfaces are connected and communicated with each other by the bus;

the memory stores executable program codes;

the processor runs a program corresponding to the executable program codes by reading the executable program codes stored in the memory, so as to execute any one of the methods for identifying a junk directory provided by the embodiments of the present application.

In a fourth aspect, embodiments of the present application further provide a storage medium for storing application software, the application software is used for executing any one of the methods for identifying a junk directory provided by the embodiments of the present application.

In a fifth aspect, embodiments of the present application further provide an application software, which is used for executing any one of the methods for identifying a junk directory provided by the embodiments of the present application.

In the embodiments of the present application, a directory to be identified is obtained; wherein, the directory to be identified is a directory generated after running of an application software; file names of files in the directory to be identified are obtained; it is determined whether the file names of the files in the directory to be identified all conform to a temporary file naming rule; and if so, the directory to be identified is determined as a junk directory. It can be seen that, in the present solution, identifying whether a directory to be identified is a junk directory is carried out by determining whether the file names of the files in the directory to be identified all conform to a temporary file naming rule, which makes full use of specific naming rules for the cached files in a directory automatically established by the application software. Thus, it is possible to effectively identify whether a directory in application software is a junk directory.

### BRIEF DESCRIPTION OF THE DRAWINGS

In order to describe the embodiments of the present application and the technical solutions in the prior art more clearly, drawings required for embodiments of the present application and the prior art will be described briefly below. It is obvious that the drawings below are only for some embodiments of the present application, and those skilled in the art can also obtain further drawings based on these drawings without any creative efforts.

FIG. 1 is a flowchart of a method for identifying a junk directory provided by the embodiments of the present application;

FIG. 2 is another flowchart of a method for identifying a junk directory provided by the embodiments of the present application; and

FIG. 3 is a schematic structural diagram of an apparatus for identifying a junk directory provided by the embodiments of the present application.

### DETAILED DESCRIPTION

In order to make the object, the technical solutions as well as advantages of the present application more apparent and understandable, the present application will be described in more detail below with reference to the appended drawings and embodiments. Obviously, the described embodiments are only some of the embodiments of the present application, rather than all of the embodiments. All other embodiments obtained based on the embodiments of the present application by those skilled in the art without any creative work fall into the protection scope defined by the present application.

In order to effectively identify whether a directory in application software is a junk directory and thereby a corresponding operation may be executed based on the identification result, embodiments of the present application provide a method and apparatus for identifying a junk directory.

First, a method for identifying a junk directory provided by the embodiments of the present application will be introduced below.

Wherein, the method for identifying a junk directory provided by the embodiments of the present application is applicable to a terminal, and also applicable to a sever. The application software corresponding to the method can be various client application software, such as various instant messaging application software, various browsing application software, various assistant application software and so on. The terminal can be a smart phone, a tablet PC or a laptop and the like with various application software installed therein. It should be noted that when the method for identifying a junk directory is applied to a terminal, it is possible to identify a directory locally on a terminal based on this method and execute a corresponding operation based on the identification result; and when the method for identifying a junk directory is applied to a server, it is possible to establish a junk directory library based on this method such that directories uploaded by various terminals can be identified according to the established junk directory library and the identification results can be fed back to the corresponding terminals so as to realize remote identification of directories in various terminals.

It should be emphasized that the directory to which the embodiments of the present application refer is a folder path, and it is able to direct to a corresponding folder by means of the directory. Further, in practical application software, a complete directory directing to a folder typically comprises: a path for indicating a local storage location and a path for indicating a location within the application software. Also, for one application software, when running in different terminals, the installation location of the application software may be different during the operation on different terminals such that the path for indicating the local storage location will change. However, the path for indicating the location within the application software does not change, and thus, in order to ensure the universality of the application software, the directory to be identified is a path for indicating the location within application software. For example, for application software “kingsoft”, “/mnt/sdcard/kingsoft/ksnmgsdk” is a complete directory directing to a folder “ksnmgsdk”, wherein, the directory to be identified may be “kingsoft/ksnmgsdk”, but does not include the path “/mnt/sdcard/” for indicating a local storage location.

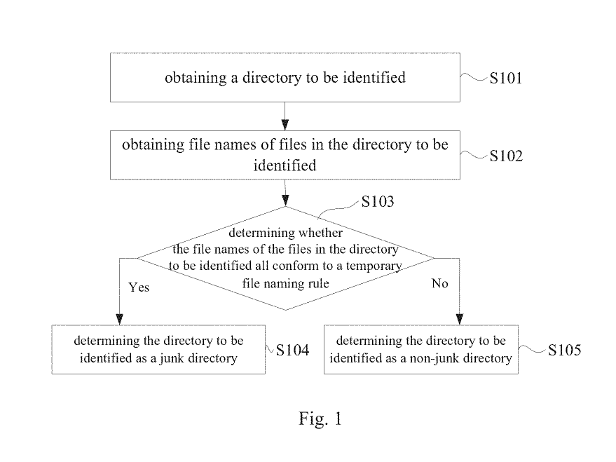

As shown in FIG. 1, a method for identifying a junk directory may comprise:

S101, obtaining a directory to be identified.

When a directory in application software needs to be identified, it is possible to obtain the directory to be identified at first and then execute subsequent processes. Wherein, the directory to be identified is a directory generated after running of the application software, and it is able to direct to a folder by means of this directory.

It is understandable for those skilled in the art that application software can automatically create a directory during the operation thereof, and the directory created automatically is a junk directory caching files that are useless to a user. Thus, if the application software corresponding to the directory to be identified had been operated, it is possible to directly obtain the directory to be identified; while the application software corresponding to the directory to be identified has not been run yet, further,

the step of obtaining a directory to be identified may comprise:

running application software simulatively; and

optionally selecting, from the directories generated after the simulative running of the application software, one directory as a directory to be identified.

It should be emphasized that the method for identifying a junk directory provided by the embodiments of the present application is introduced above by taking one directory to be identified as an example, but it can be understood that a large number of directories are provided for one application software, and identification for each directory can be carried out by applying the method provided by the embodiments of the present application.

In S102, obtaining file names of files in the directory to be identified.

Wherein, after obtaining the directory to be identified, it is possible to obtain file names of files in the directory to be identified so as to perform subsequent processes. It is understandable for those skilled in the art that picture files in cached files in a directory created automatically accounts for more than 80 percent of the total number, and thus the files may be picture files, to which the present application is not limited.

It should be emphasized that when a directory is a junk directory, the files therein are usually files cached automatically, thus it is possible to identify the directory based on a part of the files. Correspondingly, the step of obtaining file names of files in the directory to be identified may comprise: obtaining the file names of a part of the files in the directory to be identified, for example, obtaining the file names of 90 percent of the files in the directory to be identified or obtaining the file names of 95 percent of the files in the directory to be identified.

Further, in order to improve identification accuracy, the step of obtaining file names of files in the directory to be identified may comprise: obtaining the file names of all files in the directory to be identified.

In S103, determining whether the file names of the files in the directory to be identified all conform to a temporary file naming rule; if so, executing S104; otherwise executing S105.

Since files are named with a temporary file naming rule when they are cached in a junk directory, after obtaining the file names of the files in the directory to be identified, it is possible to determine whether the file names of the files in the directory to be identified all conform to the temporary file naming rule and execute different operations according to different determination results. Wherein, when it is determined that the file names of the files in the directory to be identified all conform to the temporary file naming rule, it is possible to execute S104; otherwise execute S105.

In an implementation, the step of determining whether the file names of the files in the directory to be identified all conform to a temporary file naming rule may specifically comprise:

determining whether the file names of the files in the directory to be identified are all named with a numeric string having a predetermined number of digits, and if so, it is indicated that the file names of the files in the directory to be identified all conform to the temporary file naming rule.

Wherein, the predetermined number of digits may be 8 or 11. Taking a picture file as an example, when a picture file is cached automatically, a numeric string having a predetermined number of digits for naming the picture file can be a time stamp such as 20140626204839, 20140626204840.

In an implementation, the step of determining whether the file names of the files in the directory to be identified are all consistent with a temporary file naming rule may specifically comprise:

determining whether the file names of the files in the directory to be identified are all named with a md5 character string, and if so, it is indicated that the file names of the files in the directory to be identified all conform to the temporary file naming rule.

Wherein, the md5 character string is a character string with a specific format that is formed based on a md5 algorithm. Specifically, the character string may include a part of 32 characters of 0 to 9 and A to Z (or a to z). Taking a picture file as an example, when the picture file is cached automatically, the md5 character string for naming the image file can be:

97B50E82354EE3240C8A46F2D7B5C3A0,

8FC1A28AE7C533E6599192C7CEEE8202,

2AADBD6DB9F59A83D8D40C6BFCE28031 and the like.

In another implementation, the step of determining whether the file names of the files in the directory to be identified all conform to a temporary file naming rule may specifically comprise:

determining whether the file names of the files in the directory to be identified are all named with numeric string having a predetermined number of digits, and if so, it is indicated that the file names of the files in the directory to be identified all conform to the temporary file naming rule; and

if not, continuing to determine whether the file names of the files in the directory to be identified are all named with a md5 character string, and if so, it is indicated that the file names of the files in the directory to be identified all conform to the temporary file naming rule.

In another implementation, the step of determining whether the file names of the files in the directory to be identified all conform to a temporary file naming rule may specifically comprise:

determining whether the file names of the files in the directory to be identified are all named with a md5 character string, and if so, it is indicated that the file names of the files in the directory to be identified all conform to the temporary file naming rule; and

if not, continuing to determine whether the file names of the files in the directory to be identified are all named with a numeric string having a predetermined number of digits, and if so, it is indicated that the file names of the files in the directory to be identified all conform to the temporary file naming rule.

The above specific implementation of determining whether the file names of the files in the directory to be identified are all named with numeric string having a predetermined number of digits is only for illustration, and should not be deemed as limiting the embodiments of the present application.

In S104, determining the directory to be identified as a junk directory.

Wherein, when it is determined that the file names of the files in the directory to be identified all conform to the temporary file naming rule, it is indicated that the files in the directory are all cached automatically and further indicated that this directory is created automatically during the operation of an application software, thus, the directory to be identified is determined as a junk directory.

S105, determining the directory to be identified as a non-junk directory;

Wherein, when it is determined that the file names of the files in the directory to be identified do not all conform to the temporary file naming rule, the directory to be identified is determined as a non-junk directory.

In the embodiments of the present application, a directory to be identified is obtained; wherein, the directory to be identified is a directory generated after running of an application software; file names of files in the directory to be identified are obtained; it is determined whether the file names of the files in the directory to be identified all conform to a temporary file naming rule; and if so, the directory to be identified is determined as a junk directory. It can be seen that, in the present solution, identifying whether a directory to be identified is a junk directory is carried out by determining whether the file names of the files in the directory to be identified all conform to a temporary file naming rule, which makes full use of specific naming rules for the cached files in a directory automatically established by the application software. Thus, it is possible to effectively identify whether a directory in application software is a junk directory.

Further, when the method for identifying a junk directory is applied to a terminal, after determining the directory to be identified as a junk directory, the method may further comprise:

reporting the directory to be identified to a server, so as to make the server to add the directory to be identified into a pre-established junk directory library;

or,

deleting a folder, to which the directory to be identified directs, automatically;

or,

outputting the directory to be identified, prompting a user whether to delete, and deleting the folder, to which the directory to be identified directs, after the user confirms to delete.

Further, when the method for identifying a junk directory is applied to a server, after determining the directory to be identified as a junk directory, the method may further comprise: adding the directory to be identified into a pre-established junk directory library.

Wherein, a junk directory library is improved by adding the directory to be identified into the junk directory library, so that after receiving an identification request that carries a directory uploaded by a terminal, the server matches the directory in the identification request and the junk directory in the junk directory library and feeds back a matching result to the terminal.

In order to improve identification accuracy, embodiments of the present application further provide a method for identifying a junk directory.

Wherein, the method for identifying a junk directory provided by the embodiments of the present application is applicable to a terminal, and also applicable to a sever The application software corresponding to the method can be various client application software, such as various instant messaging application software, various browsing application software, various assistant application software and so on. The terminal can be a smart phone, a tablet PC or a laptop and the like with various application software installed therein. It should be noted that when the method for identifying a junk directory is applied to a terminal, it is possible to identify a directory locally on a terminal based on this method and execute a corresponding operation based on the identification result; and when the method for identifying a junk directory is applied to a server, it is possible to establish a junk directory library based on this method such that directories uploaded by various terminals can be identified according to the established junk directory library and the identification results can be fed back to the corresponding terminals so as to realize remote identification of directories in various terminals.

It should be emphasized that the directory to which the embodiments of the present application refer is a folder path, and it is able to direct to a corresponding folder by means of the directory. Further, in practical application software, a complete directory directing to a folder typically comprises: a path for indicating a local storage location and a path for indicating a location within the application software. Also, for one application software, when running in different terminals, the installation location of the application software may be different during the operation on different terminals such that the path for indicating the local storage location will change. However, the path for indicating the location within the application software does not change, and thus, in order to ensure the universality of the application software, the directory to be identified is a path for indicating the location within application software. For example, for application software “kingsoft”, “/mnt/sdcard/kingsoft/ksnmgsdk” is a complete directory directing to a folder “ksnmgsdk”, wherein, the directory to be identified may be “kingsoft/ksnmgsdk”, but does not include the path “/mnt/sdcard/” for indicating a local storage location.

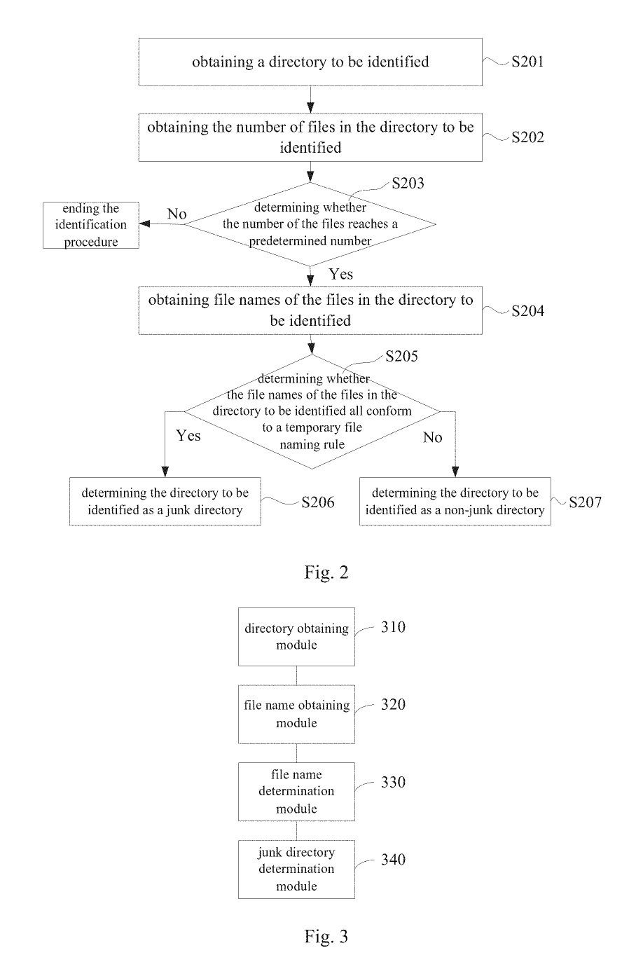

As shown in FIG. 2, a method for identifying a junk directory may comprise:

S201, obtaining a directory to be identified.

When a directory in application software needs to be identified, it is possible to obtain the directory to be identified at first and then execute subsequent processes. Wherein, the directory to be identified is a directory generated after running of the application software, and it is able to direct to a folder by means of this directory.

It is understandable for those skilled in the art that application software can automatically create a directory during the operation thereof, and the directory created automatically is a junk directory caching files that are useless to a user. Thus, if the application software corresponding to the directory to be identified had been operated, it is possible to directly obtain the directory to be identified; while the application software corresponding to the directory to be identified has not been run yet, further,

the step of obtaining a directory to be identified may comprise:

running application software simulatively; and

optionally selecting, from the directories generated after the simulative running of the application software, one directory as a directory to be identified.

It should be emphasized that the method for identifying a junk directory provided by the embodiments of the present application is introduced above by taking one directory to be identified as an example, but it can be understood that a large number of directories are provided for one application software, and identification for each directory can be carried out by applying the method provided by the embodiments of the present application.

In S202, obtaining the number of files in the directory to be identified.

In S203, determining whether the number of the files reaches a predetermined number, and if so, triggering S204; otherwise, finishing the identification procedure;

In order to improve accuracy, it is possible to execute the subsequent determinations when there are many files in a directory. Thus, after obtaining a directory to be identified, it is possible to obtain the number of the files in the directory to be identified and further determine whether the number of the files reaches a predetermined number, and if so, it is possible to execute S204, otherwise, just finishing the identification procedure.

Wherein, the predetermined number can be 10, 12 or 15, and can be set according to actual situations.

In S204, obtaining file names of the files in the directory to be identified.

Wherein, when it is determined that the number of the files reaches a predetermined number, it is possible to obtain the file names of the file in the directory to be identified so as to perform subsequent processes. It is understandable for those skilled in the art that picture files in the cached files in a directory created automatically accounts for more than 80 percent of the total number, thus the files may be picture files, to which the present application is not limited.

It should be emphasized that when a directory is a junk directory, the files therein are usually files cached automatically, thus it is possible to identify the directory based on a part of the files. Correspondingly, the step of obtaining file names of files in the directory to be identified may comprise: obtaining the file names of a part of the files in the directory to be identified, for example, obtaining the file names of 90 percent of the files in the directory to be identified or obtaining the file names of 95 percent of the files in the directory to be identified.

Further, in order to improve identification accuracy, the step of obtaining file names of files in the directory to be identified may comprise: obtaining the file names of all files in the directory to be identified.

In S205, determining whether the file names of the files in the directory to be identified all conform to a temporary file naming rule; if so, executing S206; otherwise executing S207.

Since files are named with a temporary file naming rule when they are cached in a junk directory, after obtaining the file names of the files in the directory to be identified, it is possible to determine whether the file names of the files in the directory to be identified all conform to the temporary file naming rule and execute different operations according to different determination results. Wherein, when it is determined that the file names of the files in the directory to be identified all conform to the temporary file naming rule, it is possible to execute S206; otherwise execute S207.

In an implementation, the step of determining whether the file names of the files in the directory to be identified all conform to a temporary file naming rule may specifically comprise:

determining whether the file names of the files in the directory to be identified are all named with a numeric string having a predetermined number of digits, and if so, it is indicated that the file names of the files in the directory to be identified all conform to the temporary file naming rule.

Wherein, the predetermined number of digits may be 8 or 11. Taking a picture file as an example, when a picture file is cached automatically, a numeric string having a predetermined number of digits for naming the picture file can be a time stamp such as 20140626204839, 20140626204840.

In an implementation, the step of determining whether the file names of the files in the directory to be identified are all consistent with a temporary file naming rule may specifically comprise:

determining whether the file names of the files in the directory to be identified are all named with a md5 character string, and if so, it is indicated that the file names of the files in the directory to be identified all conform to the temporary file naming rule.

Wherein, the md5 character string is a character string with a specific format that is formed based on a md5 algorithm. Specifically, the character string may include a part of 32 characters of 0 to 9 and A to Z (or a to z). Taking a picture file as an example, when the picture file is cached automatically, the md5 character string for naming the image file can be:
97B50E82354EE3240C8A46F2D7B5C3A0,
8FC1A28AE7C533E6599192C7CEEE8202,
2AADBD6DB9F59A83D8D40C6BFCE28031 and the like.

In another implementation, the step of determining whether the file names of the files in the directory to be identified all conform to a temporary file naming rule may specifically comprise:

determining whether the file names of the files in the directory to be identified are all named with numeric string having a predetermined number of digits, and if so, it is indicated that the file names of the files in the directory to be identified all conform to the temporary file naming rule; and

if not, continuing to determine whether the file names of the files in the directory to be identified are all named with a md5 character string, and if so, it is indicated that the file names of the files in the directory to be identified all conform to the temporary file naming rule.

In another implementation, the step of determining whether the file names of the files in the directory to be identified all conform to a temporary file naming rule may specifically comprise:

determining whether the file names of the files in the directory to be identified are all named with a md5 character string, and if so, it is indicated that the file names of the files in the directory to be identified all conform to the temporary file naming rule; and

if not, continuing to determine whether the file names of the files in the directory to be identified are all named with a numeric string having a predetermined number of digits, and if so, it is indicated that the file names of the files in the directory to be identified all conform to the temporary file naming rule.

The above specific implementation of determining whether the file names of the files in the directory to be identified are all named with numeric string having a predetermined number of digits is only for illustration, and should not be deemed as limiting the embodiments of the present application.

In S206, determining the directory to be identified as a junk directory.

Wherein, when it is determined that the file names of the files in the directory to be identified all conform to temporary file naming rule, it is indicated that the files in the directory are all cached automatically and further indicated that this directory is created automatically during the operation of an application software, thus, the directory to be identified is determined as a junk directory.

In S207, determining the directory to be identified as a non-junk directory.

Wherein, when it is determined that the file names of the files in the directory to be identified do not all conform to the temporary file naming rule, the directory to be identified is determined as a non-junk directory.

In the embodiments of the present application, a directory to be identified is obtained, wherein the directory to be identified is a directory generated after running of an application software; the number of the files in the directory to be identified is obtained, when it is determined that the number of the files reaches a predetermined number, it is possible to obtain the file names of the files in the directory to be identified; it is determined whether the file names of the files in the directory to be identified all conform to a temporary file naming rule; and if so, the directory to be identified is determined as a junk directory. It can be seen that in the present solution, identifying whether a directory to be identified is a junk directory is carried out by determining whether the file names of the files in the directory to be identified all conform to temporary file naming rule, which makes full use of specific naming rules for the cached files in a directory automatically established by the application software. Thus, it is possible to effectively identify whether a directory in application software is a junk directory. Moreover, continuing the identification procedures when the number of the files in a directory being enough can further improve identification accuracy.

Furthermore, when the method for identifying a junk directory is applied to a terminal, after determining the directory to be identified as a junk directory, the method may further comprise:

reporting the directory to be identified to a server, so as to make the server to add the directory to be identified into a pre-established junk directory library;

or,

deleting a folder, to which the directory to be identified directs, automatically;

or,

outputting the directory to be identified, prompting a user whether to delete, and deleting the folder, to which the directory to be identified directs, after the user confirms to delete.

Further, when the method for identifying a junk directory is applied to a server, after determining the directory to be identified as a junk directory, the method may further comprise: adding the directory to be identified into a pre-established junk directory library.

Wherein, a junk directory library is improved by adding the directory to be identified into the junk directory library, so that after receiving an identification request that carries a directory uploaded by a terminal, the server matches the directory in the identification request and the junk directory in the junk directory library and feeds back a matching result to the terminal.

Corresponding to the above method embodiments, embodiments of the present application provide an apparatus for identifying a junk directory identification. As shown in FIG. 3, the apparatus may comprise:

a directory obtaining module 310 for obtaining a directory to be identified; wherein, the directory to be identified is a directory generated after running of an application software;

a file name obtaining module 320 for obtaining file names of files in the directory to be identified;

a file name determination module 330 for determining whether the file names of the files in the directory to be identified all conform to a temporary file naming rule, and if so, triggering a junk directory determination module; and

the junk directory determination module 340 for determining the directory to be identified as a junk directory.

In the embodiments of the present application, a directory to be identified is obtained; wherein, the directory to be identified is a directory generated after running of an application software; file names of files in the directory to be identified are obtained; it is determined whether the file names of the files in the directory to be identified all conform to a temporary file naming rule; and if so, the directory to be identified is determined as a junk directory. It can be seen that, in the present solution, identifying whether a directory to be identified is a junk directory is carried out by determining whether the file names of the files in the directory to be identified all conform to a temporary file naming rule, which makes full use of specific naming rules for the cached files in a directory automatically established by the application software. Thus, it is possible to effectively identify whether a directory in application software is a junk directory.

Further, the junk directory identification apparatus provided by the embodiments of the present application may also comprise:

a file number obtaining module for obtaining the number of files in the directory to be identified before obtaining the file names of the files in the directory to be identified; and

a file number determination module for determining whether the number of the files reaches a predetermined number, and if so, triggering the file name obtaining module.

Specifically, the file name determination module 330 may comprise:

a first file name determination unit for determining whether the file names of the files in the directory to be identified are all named with a numeric string having a predetermined number of digits, and if so, it is indicated that the file names of the files in the directory to be identified all conform to a temporary file naming rule, then triggering the junk directory determination module.

Specifically, the file names determination module 330 may comprise:

a second file name determination unit for determining whether the file names of the files in the directory to be identified are all named with a md5 character string, and if so, it is indicated that the file names of the files in the directory to be identified all conform to the temporary file naming rule, then triggering the junk directory determination module.

Specifically, the file names determination module 330 may comprise:

a second file name determination unit for determining whether the file names of the files in the directory to be identified are all named with a numeric string having a predetermined number of digits, and if so, it is indicated that the file names of the files in the directory to be identified all conform to the temporary file naming rule, then triggering the junk directory determination module; and

if not, continuing to determine whether the file names of the files in the directory to be identified are all named with a md5 character string, and if so, it is indicated that the file names of the files in the directory to be identified all conform to the temporary file naming rule, then triggering the junk directory determination module.

Specifically, the file name obtaining module 320 is specifically used for

obtaining file names of all files in the directory to be identified.

Specifically, the directory obtaining module 310 may comprise:

a simulation-running unit for running the application software simulatively; and

a directory determination unit for optionally selecting, from directories generated after the simulative running of the application software, one directory as the directory to be identified.

Further, when the apparatus for identifying a junk directory provided by the embodiments of the present application is applied to a terminal, the apparatus may also comprise:

a first processing module for reporting the directory to be identified to a server after the directory to be identified is determined as a junk directory, so as to make the server to add the directory to be identified into a pre-established junk directory library;

or,

a second processing module for automatically deleting a folder, to which the directory to be identified directs, after the directory to be identified is determined as a junk directory;

or,

a third processing module for outputting, after the directory to be identified is determined as a junk directory, the directory to be identified, prompting a user whether to delete, and deleting a folder, to which the directory to be identified directs, after the user confirms to delete.

Further, when the apparatus for identifying a junk directory provided by the embodiments of the present application is applied to a server, the apparatus may also comprise:

a fourth processing module for adding the directory to be identified into a pre-established junk directory library after the directory to be identified is determined as a junk directory.

Specifically, the files may be picture files.

Further, embodiments of the present application further provide an electronic apparatus, which comprises a processor, a memory, communication interfaces and a bus;

the processor, the memory and the communication interfaces are connected and communicated with each other by the bus;

the memory stores executable program codes;

the processor runs a program corresponding to the executable program codes by reading the executable program codes stored in the memory, so as to execute any one of the methods for identifying a junk directory provided by the embodiments of the present application. Wherein, a method for identifying a junk directory provided by the embodiments of the present application comprises:

obtaining a directory to be identified, wherein, the directory to be identified is a directory generated after running of application software;

obtaining file names of files in the directory to be identified;

determining whether the file names of the files in the directory to be identified all conform to a temporary file naming rule; and

if so, determining the directory to be identified as a junk directory.

Further, embodiments of the present application further provide a storage medium for storing application software, which is used for executing any one of the methods for identifying a junk directory provided by the embodiments of the present application. Wherein, a method for identifying a junk directory provided by the embodiments of the present application comprises:

obtaining a directory to be identified, wherein, the directory to be identified is a directory generated after running of application software;

obtaining file names of files in the directory to be identified;

determining whether the file names of the files in the directory to be identified all conform to a temporary file naming rule; and

if so, determining the directory to be identified as a junk directory.

Furthermore, embodiments of the present application also provide an application software, which is used for executing any one of the methods for identifying a junk directory identification provided by the embodiments of the present application. Wherein, a method for identifying a junk directory provided by the embodiments of the present application comprises:

obtaining a directory to be identified, wherein, the directory to be identified is a directory generated after running of application software;

obtaining file names of files in the directory to be identified;

determining whether the file names of the files in the directory to be identified all conform to a temporary file naming rule; and

if so, determining the directory to be identified as a junk directory.

The embodiments of the system or apparatus are briefly described and reference can be made to the description of the embodiments of the method for its related contents since the embodiments of the system or apparatus are substantially similar to those of the method.

It should be noted that the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or apparatuses comprising a series of elements comprise not only those elements listed, but also other elements not specifically listed or the elements intrinsic to these processes, methods, articles, or apparatuses. Without further limitations, elements limited by the wording “comprise(s) a/an . . . ” do not exclude that there are additional identical elements in the processes, methods, articles, or apparatuses which comprise the listed elements.

It can be understood by those ordinary skilled in the art that all or a part of steps in the implementations of the above method can be carried out by related hardware being instructed by programs, which can be stored in computer readable storage medium, such as ROM/RAM, disk and optical disk and the like.

The embodiments described above are just preferable embodiments of the present application, and not indented to limit the present application. Any modifications, alternatives, improvements or the like within the spirit and principle of the present application shall be comprised in the protection scope of the present application.

What is claimed is:

1. A method for identifying a junk directory, characterized in that the method comprises:
obtaining a directory to be identified, wherein, the directory to be identified is a directory generated after running of application software;
obtaining file names of files in the directory to be identified;
determining whether the file names of the files in the directory to be identified all conform to a temporary file naming rule; and
if so, determining the directory to be identified as a junk directory.

2. The method according to claim 1, characterized in that, before obtaining file names of files in the directory to be identified, the method further comprises:
obtaining the number of the files in the directory to be identified; and
determining whether the number of the files reaches a predetermined number, and if so, executing the step of obtaining file names of files in the directory to be identified again.

3. The method according to claim 1, characterized in that, the step of determining whether the file names of the files in the directory to be identified all conform to a temporary file naming rule comprises:
determining whether the file names of the files in the directory to be identified are all named with a numeric string having a predetermined number of digits, and if so, it is indicated that the file names of the files in the directory to be identified all conform to the temporary file naming rule.

4. The method according to claim 1, characterized in that, the step of determining whether the file names of the files in the directory to be identified all conform to a temporary file naming rule comprises:
determining whether the file names of the files in the directory to be identified are all named with a md5 character string, and if so, it is indicated that the file names of the files in the directory to be identified all conform to the temporary file naming rule.

5. The method according to claim 1, characterized in that, the step of determining whether the file names of the files in the directory to be identified all conform to a temporary file naming rule comprises:
determining whether the file names of the files in the directory to be identified are all named with a numeric string having a predetermined number of digits, and if so, it is indicated that the file names of the files in the directory to be identified all conform to the temporary file naming rule; and
if not, continuing to determine whether the file names of the files in the directory to be identified are all named with a md5 character string, and if so, it is indicated that the file names of the files in the directory to be identified all conform to the temporary file naming rule.

6. The method according to claim 1, characterized in that, the step of obtaining file names of files in the directory to be identified comprises:
obtaining file names of all files in the directory to be identified.

7. The method according to claim 1, characterized in that, the step of obtaining a directory to be identified comprises:
running the application software simulatively; and
optionally selecting, from directories generated after the simulative running of the application software, one directory as the directory to be identified.

8. The method according to claim 1, characterized in that, after determining the directory to be identified as a junk directory, the method further comprises one of the following steps:
reporting the directory to be identified to a server, so as to make the server to add the directory to be identified into a pre-established junk directory library;
deleting a folder, to which the directory to be identified directs, automatically;
outputting the directory to be identified, prompting a user whether to delete, and deleting a folder, to which the directory to be identified directs, after the user confirms to delete.

9. The method according to claim 1, characterized in that, after determining the directory to be identified as a junk directory, the method further comprises:
adding the directory to be identified into a pre-established junk directory library.

10. The method according to claim 1, characterized in that, the files are picture files.

11. An electronic apparatus for identifying a junk directory, characterized in that the apparatus comprises: a processor, a memory, communication interfaces and a bus;
the processor, the memory and the communication interfaces are connected and communicated with each other by the bus;
the memory stores executable program codes;
the processor runs a program corresponding to the executable program codes by reading the executable program codes stored in the memory to perform the following steps:
obtaining a directory to be identified, wherein, the directory to be identified is a directory generated after running of an application software;
obtaining file names of files in the directory to be identified;
determining whether the file names of the files in the directory to be identified all conform to a temporary file naming rule; and
if so,
determining the directory to be identified as a junk directory.

12. The electronic apparatus according to claim 11, characterized in that, before the step of obtaining file names of files in the directory to be identified, the processor further performs the following steps:
obtaining the number of files in the directory to be identified; and
determining whether the number of the files reaches a predetermined number, and if so, executing the step of obtaining file names of files in the directory to be identified again.

13. The electronic apparatus according to claim 11, characterized in that, the step of determining whether the file names of the files in the directory to be identified all conform to a temporary file naming rule comprises:
determining whether the file names of the files in the directory to be identified are all named with a numeric string having a predetermined number of digits, and if so, it is indicated that the file names of the files in the directory to be identified all conform to a temporary file naming rule.

14. The electronic apparatus according to claim 11, characterized in that, the step of determining whether the file names of the files in the directory to be identified all conform to a temporary file naming rule comprises:
determining whether the file names of the files in the directory to be identified are all named with a md5 character string, and if so, it is indicated that the file names of the files in the directory to be identified all conform to the temporary file naming rule.

15. The electronic apparatus according to claim 11, characterized in that, the step of determining whether the file names of the files in the directory to be identified all conform to a temporary file naming rule comprises:
determining whether the file names of the files in the directory to be identified are all named with a numeric string having a predetermined number of digits, and if so, it is indicated that the file names of the files in the directory to be identified all conform to the temporary file naming rule; and
if not, continuing to determine whether the file names of the files in the directory to be identified are all named with a md5 character string, and if so, it is indicated that the file names of the files in the directory to be identified all conform to the temporary file naming rule.

16. The electronic apparatus according to claim 11, characterized in that, the step of obtaining file names of files in the directory to be identified comprises:
obtaining file names of all files in the directory to be identified.

17. The electronic apparatus according to claim 11, characterized in that, the step of obtaining a directory to be identified comprises:
running the application software simulatively; and
optionally selecting, from directories generated after the simulative running of the application software, one directory as the directory to be identified.

18. The electronic apparatus according to claim 11, characterized in that, after determining the directory to be identified as a junk directory, the processor further performs one of the following steps:
reporting the directory to be identified to a server, so as to make the server to add the directory to be identified into a pre-established junk directory library;
automatically deleting a folder, to which the directory to be identified directs;
the directory to be identified, prompting a user whether to delete, and deleting a folder, to which the directory to be identified directs, after the user confirms to delete.

19. The electronic apparatus according to claim 11, characterized in that, after determining the directory to be identified as a junk directory, the processor further performs the following step:
adding the directory to be identified into a pre-established junk directory library.

20. The electronic apparatus according to claim 11, characterized in that, the files are picture files.
